(19) United States
(12) Patent Application Publication
(10) Pub. No.: US 2025/0073936 A1
(43) Pub. Date: Mar. 6, 2025

(54) COMPOSITE BLADE SYSTEM

(71) Applicant: GO Technical Services and Consulting Inc., Thompsons Station, TN (US)

(72) Inventor: Vladimir P. Gutsman, Thompsons Station, TN (US)

(21) Appl. No.: 18/822,128

(22) Filed: Aug. 31, 2024

Related U.S. Application Data
(60) Provisional application No. 63/536,274, filed on Sep. 1, 2023.

(51) Int. Cl. B26D 1/00; A22C 17/00; A22C 21/00; B26D 7/26

(52) U.S. Cl. CPC B26D 1/0006; A22C 17/0006; A22C 21/0023; B26D 7/2621; B26D 2001/0033; B26D 2001/006

(57) ABSTRACT

This disclosure relates generally to cutting processes, composite blades, blade systems, and manufacturing and use thereof. In various aspects, a composite blade system includes a plurality of blade segments, where each blade segment includes a body having top edge, a bottom edge, and opposing side edges extending therebetween. The blade segments also include a projection on a first side edge of the body, a slot on a second side edge of the body opposite the first side edge, and a void disposed near the bottom edge of the body. The composite blade system may additionally include a hub connectable to each of the plurality of blade segments via the void and a locking plate connectable to the hub.

### CROSS-REFERENCE TO RELATED APPLICATION

A claim for priority to the Sep. 1, 2023 filing date of U.S. Provisional Patent Application No. 63/536,274, titled COMPOSITE BLADE SYSTEM (“the '274 Provisional Application”), is hereby made. The entire disclosure of the '274 Provisional Application is hereby incorporated herein.

### TECHNICAL FIELD

This disclosure relates generally to cutting processes, blades for cutting processes, composite blades, and manufacturing and use thereof.

### SUMMARY

Disclosed are systems, devices, and/or methods of use thereof regarding cutting processes, blades for cutting processes, composite blades, and manufacturing and use thereof. In various aspects, a composite blade system includes a plurality of blade segments, where each blade segment includes a body having top edge, a bottom edge, and opposing side edges extending therebetween. The blade segments also include a projection on a first side edge of the body, a slot on a second side edge of the body opposite the first side edge, and a void disposed near the bottom edge of the body. The composite blade system additionally includes a hub connectable to each of the plurality of blade segments via the void and a locking plate connectable to the hub. The locking plate may be for locking a position of the plurality of blade segments about the hub. In some embodiments, a first blade segment is connectable to a second blade segment such that the projection of the first blade segment is received within the slot of the second blade segment.

In some embodiments, a composite blade includes a first plurality of bade segments, where each of the first plurality of blade segments have a cutting edge of a first sharpness. The composite blade also includes a second plurality of bade segments, where each of the second plurality of blade segments have a cutting edge of a second sharpness with the first sharpness being sharper than the second sharpness. The composite blade may also include a hub for receiving the first and second plurality of blade segments. In some embodiments, the first and second plurality of blade segments are alternatingly received by the hub. The composite blade may further include a locking plate connectable to the hub and for locking a position of the first and second plurality of blade segments within the hub.

In some embodiments, a cutting method may include selecting a composite blade having a first outer diameter for a first machine, where the composite blade comprises a plurality of blade segments, a first hub, and a locking plate. The method may also include equipping the first machine with the composite blade through the first hub and performing a cutting process with the first machine using the composite blade. The method may further include selecting a second hub for the composite blade and equipping a second machine with the composite blade through the second hub, where the second hub provides the composite blade with a second diameter for the second machine. The method may include performing a cutting process with the second machine using the composite blade.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

### In the Drawings:

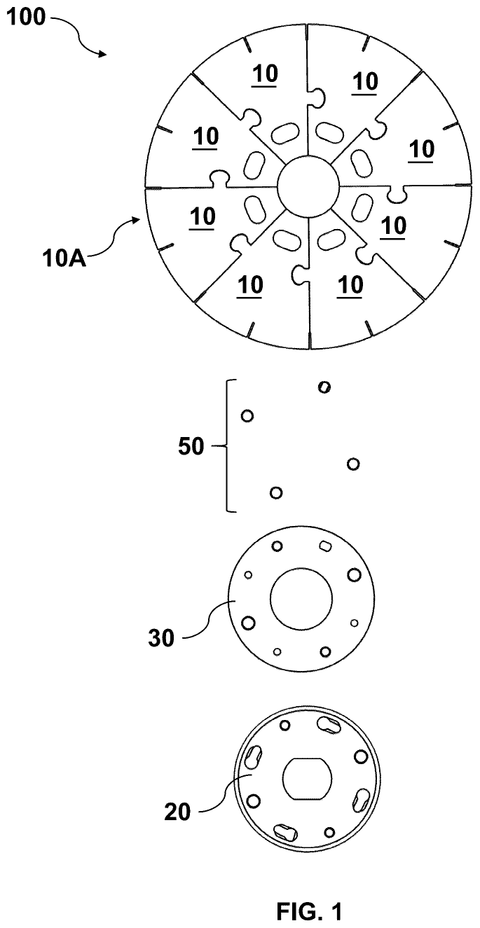

FIG. 1 illustrates a plan view of a composite blade, in a disassembled configuration, according to embodiments of the present disclosure;

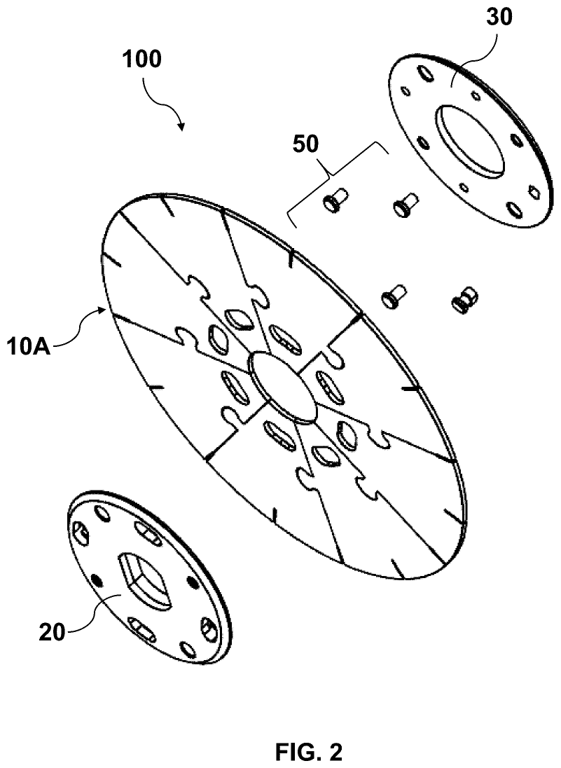

FIG. 2 illustrates an exploded perspective view of the composite blade of FIG. 1;

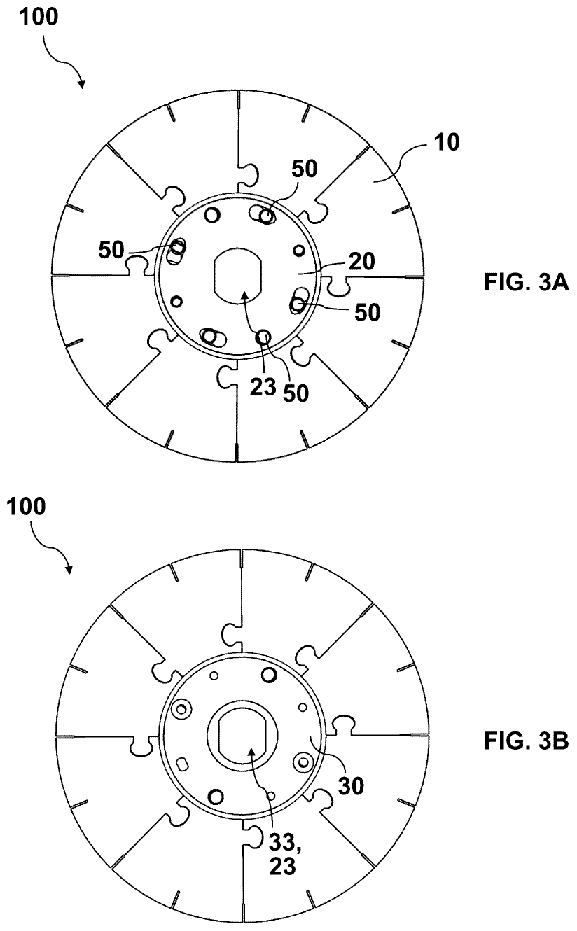

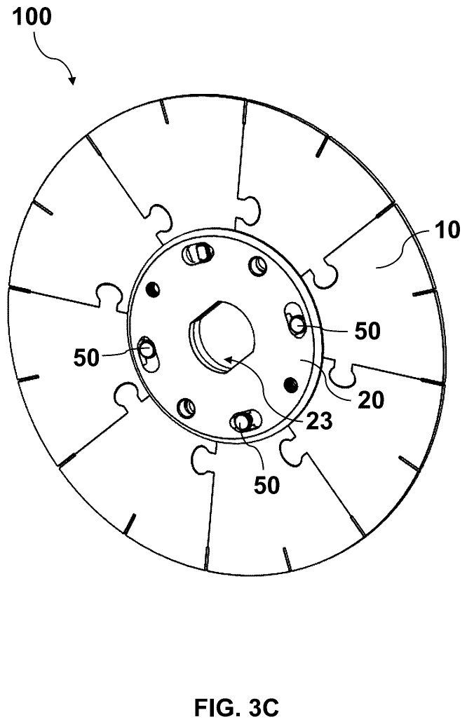

FIGS. 3A-3B illustrate top and bottom plan views, respectively, and FIG. 3C illustrates a top perspective view of the composite blade of FIGS. 1-2 in an assembled configuration;

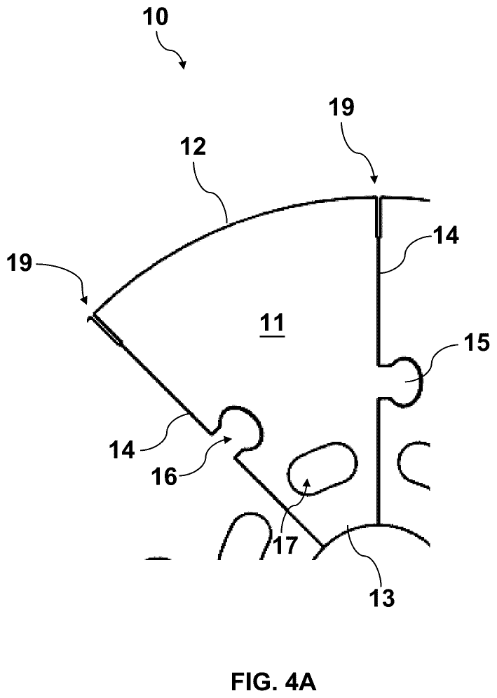

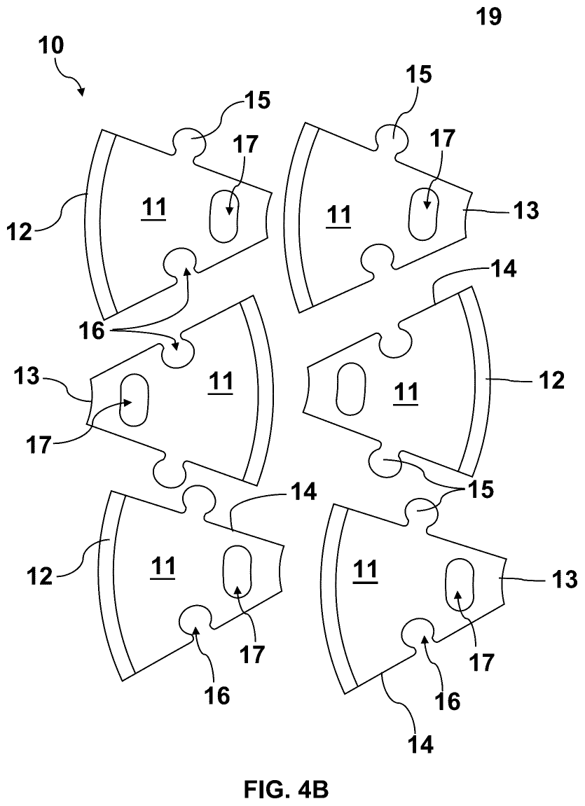

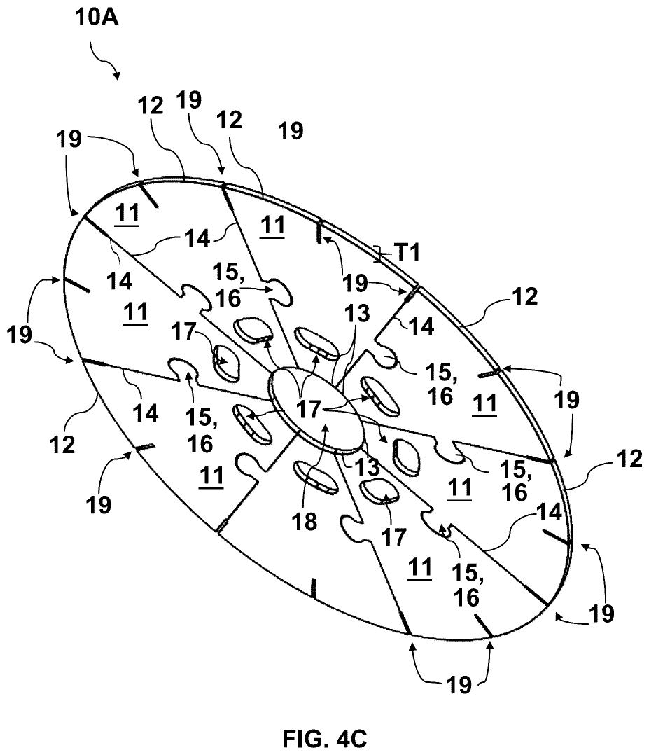

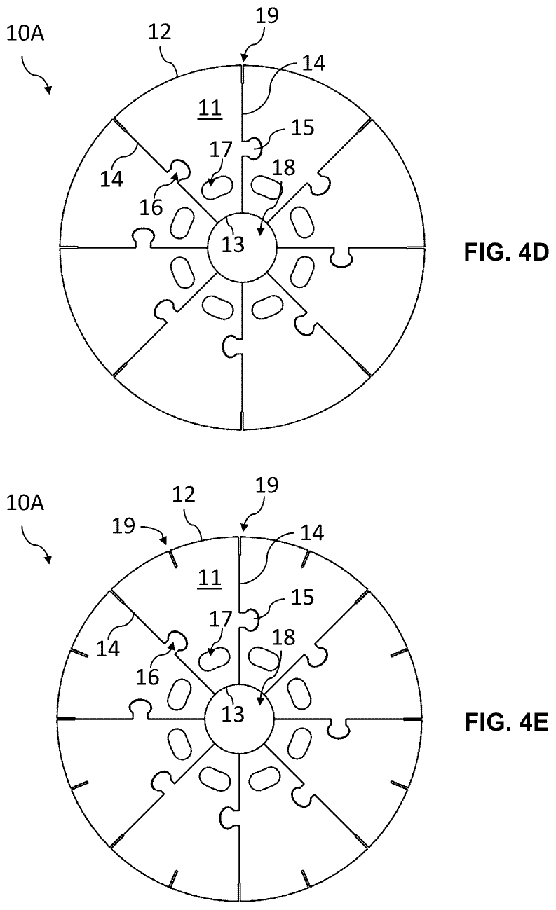

FIGS. 4A-4E illustrate views of blade segments to be used with the composite blade or blade systems of FIGS. 1-2;

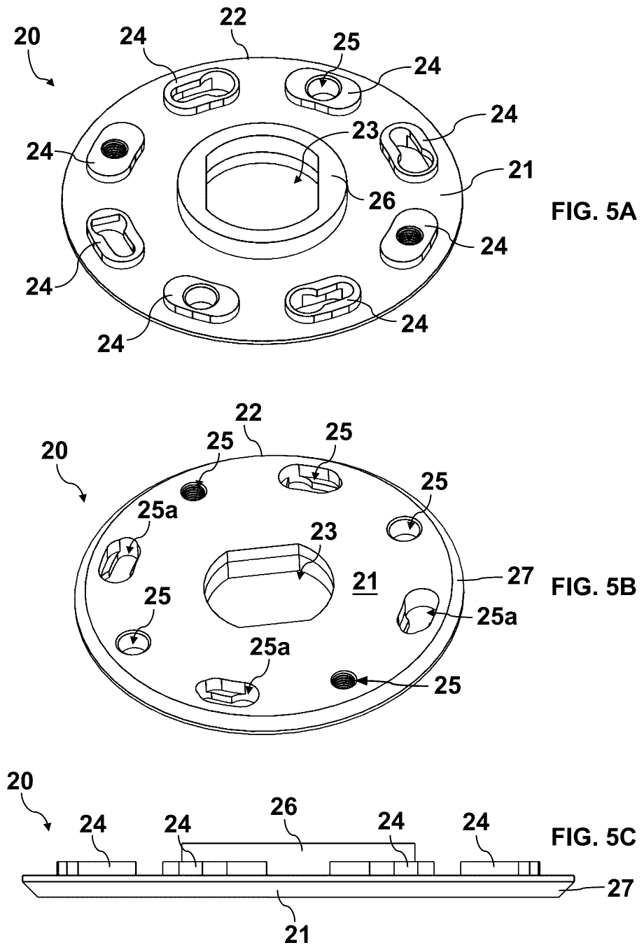

FIGS. 5A-5C illustrate views of the hub or receiver from the composite blade or blade systems of FIGS. 1-2;

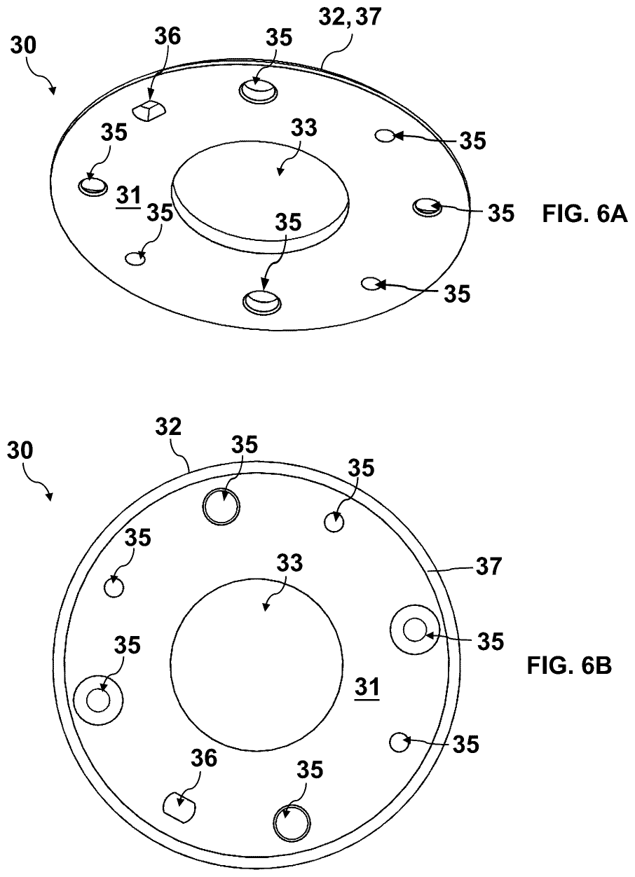

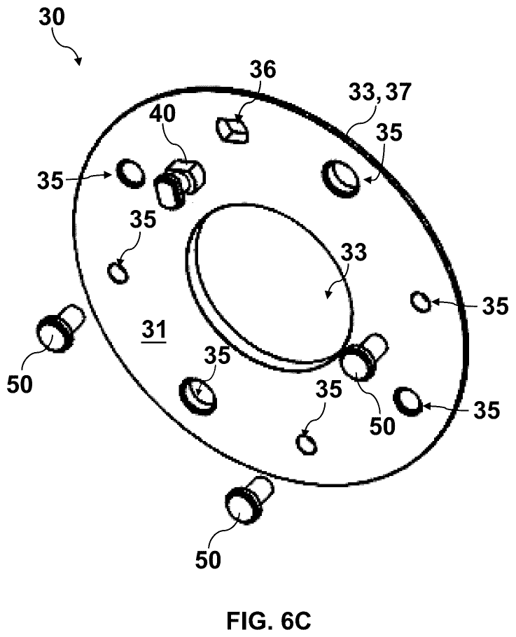

FIGS. 6A-6C illustrate views of the locking plate from the composite blade of FIGS. 1-2;

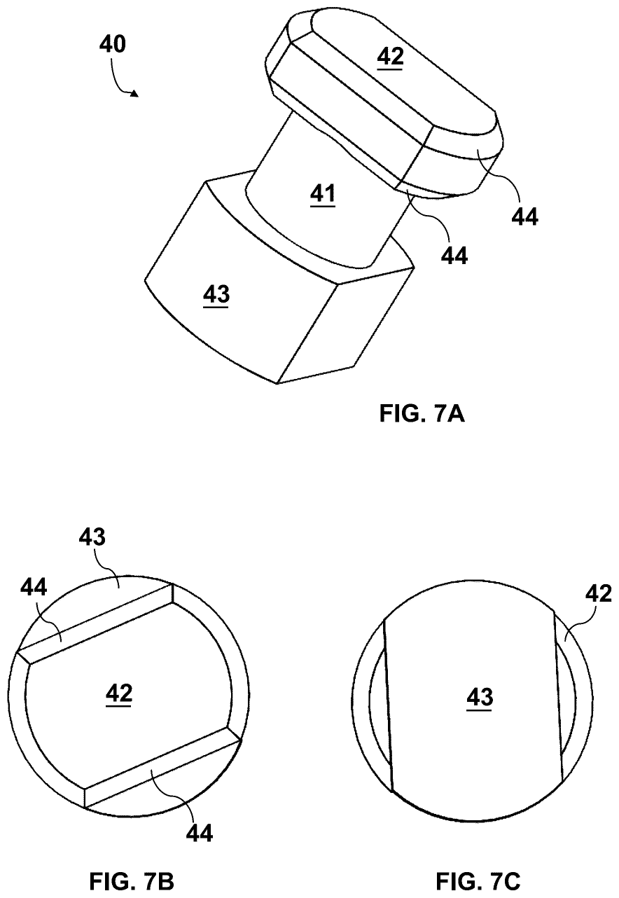

FIGS. 7A-7C illustrate views of a locking pin for use with the composite blade or blade system of FIGS. 1-2;

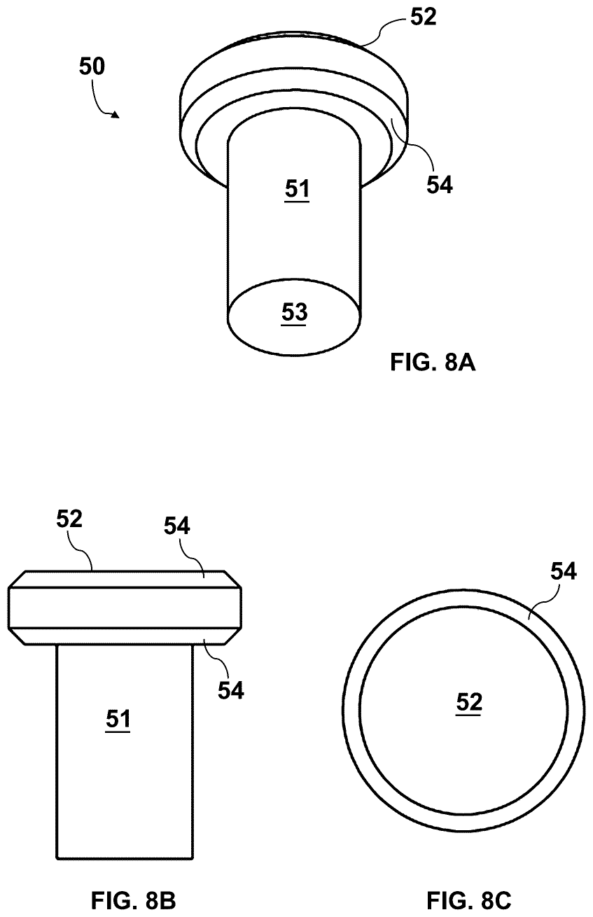

FIGS. 8A-8C illustrate views of a pin for use with the composite blade or blade system of FIGS. 1-2;

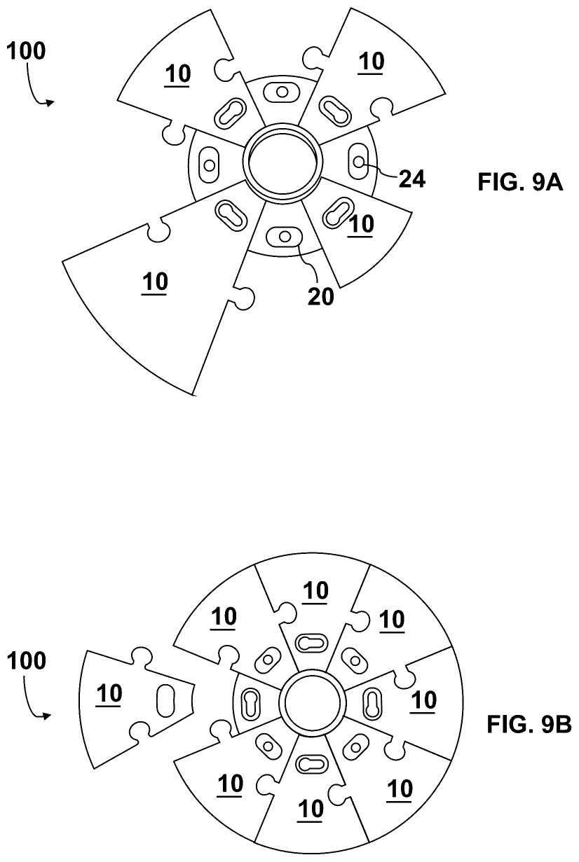

FIGS. 9A-9C illustrate views of the composite blade or blade system of FIGS. 1-2 in various disassembled configurations;

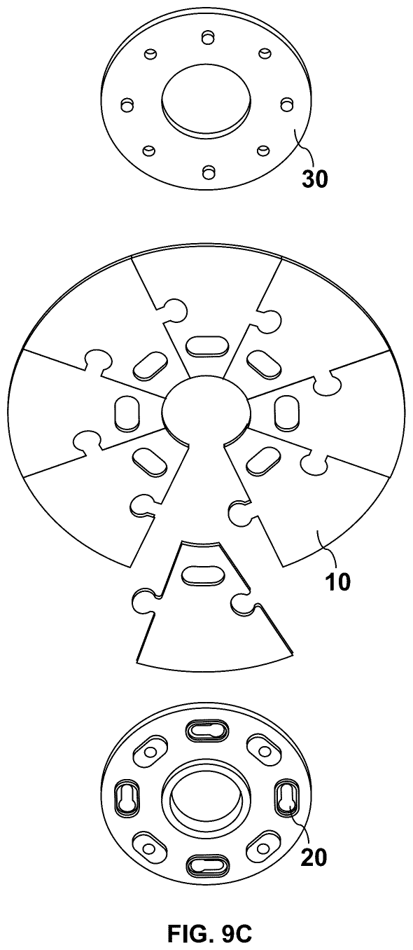

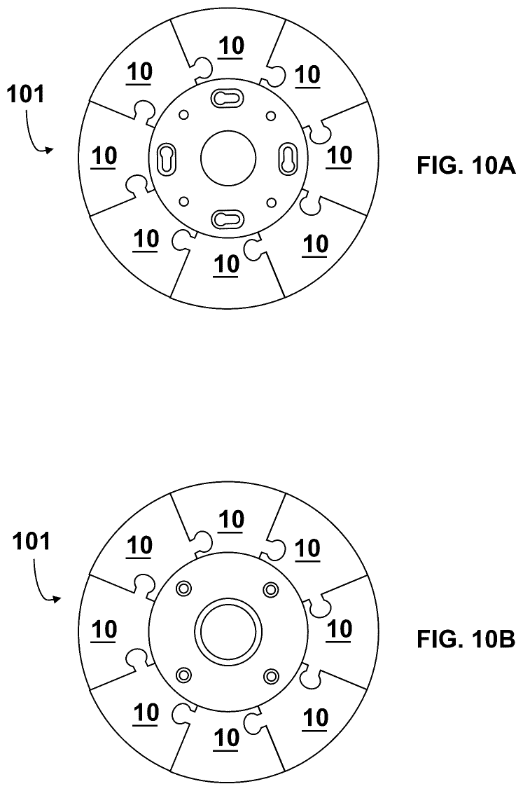

FIGS. 10A-10B illustrate another embodiment of a composite blade according to the present disclosure; and

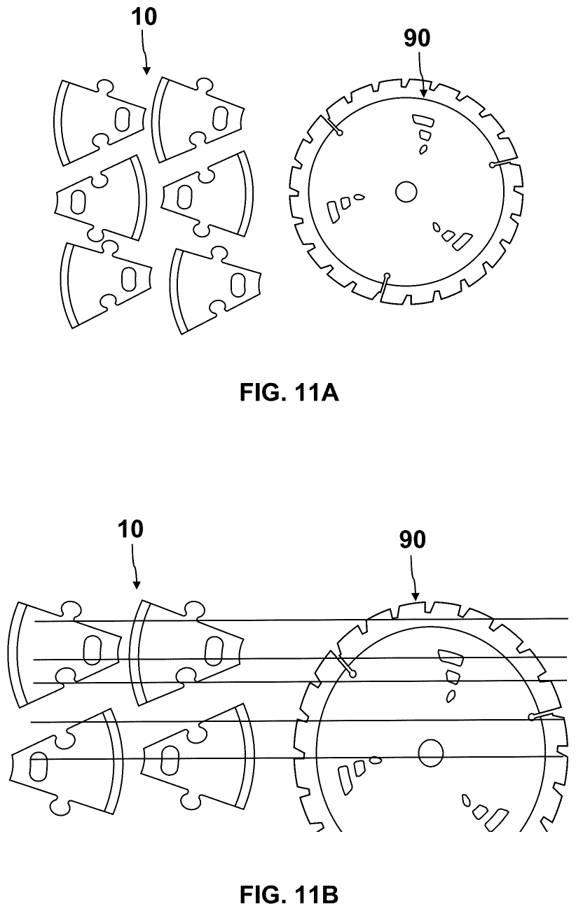

FIGS. 11A-11B illustrate a comparison of the blade segments from FIGS. 4A-4E to a conventional circular blade.

### DETAILED DESCRIPTION

Many various types of items or products require cutting or undergo a cutting process as part of their manufacturing or processing operations before being sold on the market. For example, rugs and other textile-based products require cutting at many stages of processing (e.g., initial sizing of fabric, cutting fabric to shape, cutting excess edges, etc.). As another example, many meat and poultry products require various levels of cutting before being sold (e.g., chicken wings, thighs, and drumstick are often separated from a whole chicken before being packaged and individually sold).

Many cutting facilities, whether processing textiles, meat, or other types of products, incorporate multiple machines into the facilities. Each machine may utilize a blade to perform a cutting process and require a particular size for the blade. Generally, the size of blade is correlated to the outer diameter of the blade used within the machine. Typically, each machine must have its own blade that matches the particular size requirements or parameters for the machine. For example, a first machine may only use blades having outer diameters of about 200 mm and a second machine may only use blades having outer diameters of about 500 mm. Thus, blades for the first machine cannot be used with the second machine as they simply will not fit within the second machine.

For example, meat and poultry facilities may utilize anatomical cutting blades. Current anatomical cutting blades are made of one single piece of stainless steel, and are single diameter units that are made specifically for each manufacturer's machine and each food being processed.

Due to this individuality of machines, facilities need to have numerous types and sizes of blades on hand in order to operate all of the machines present in the facility. This leads to increased costs in terms of space (more storage space is required to store the numerous types and sizes of blades) as well as money (more individual blades need to be purchased as blades cannot be used across multiple machines).

The individual nature of the machines and blades also complicates the blade manufacturing process. For example, each size of blade must be manufactured individually. That is, a 200 mm blade must be manufactured, a 500 mm blade must be manufactured, etc. Manufacturing of these blades, regardless of size, is a complicated, multi-step process. Generally, metal is machined to arrive at a blade-like shape. Then, the metal is hardened to the appropriate level for the end use of the blade (e.g., cutting versus dull edges undergo differing hardening processes). Then, the blade undergoes a second round of machining before polishing and/or sharpening. Each step of the manufacturing process must be repeated for each individual blade, leading to increased costs for the blade. When specialty blades are required (e.g., blades having multiple cutting surfaces or angles), the manufacturing process becomes even more complicated and costly.

Additionally, each individual blade must undergo its own sharpening process, adding costs in time and money to the manufacturing process for each blade. CNC machines can be programmed to sharpen blades, particularly when a precise sharpening process is required. For example, specialty blades having multiple cutting surfaces or angles require a highly precise sharpening process. Often, the highly precise sharpening process is both expensive and hard to find, as only a few manufacturers have the capacity to perform such a precise process.

Not only is the manufacturing process complicated and expensive, but shipping and transporting lots of individual blades adds time and money to the process.

Embodiments of the present disclosure address these and other issues. The composite blades or systems of the present disclosure are based on a three-piece system of a blade hub or receiver, a blade composed of a plurality of blade segments, and a blade locking plate. The new blade system can easily be substituted for any current blade on any manufacturer's machine. It is not restricted to one diameter size and can be adapted to any manufacturer's processing machine using a specific blade hub as a base.

For example, the disclosed composite blades and blade systems allow for streamlining of the manufacturing and sharpening processes. Specifically, by utilizing blade segments within a composite blade, fewer individually sized blades need to be manufactured, resulting in a simpler and quicker blade manufacturing operation. This also means that fewer individually sized blades need to be packaged and shipped to facilities, cutting down on transportation costs. Additionally, this means that fewer individually sized blades need to be kept in stock at cutting facilities, reducing inventory and storage space requirements.

In various aspects, a composite blade system includes a plurality of blade segments, where each blade segment includes a body having top edge, a bottom edge, and opposing side edges extending therebetween. The blade segments also include a projection on a first side edge of the body, a slot on a second side edge of the body opposite the first side edge, and a void disposed near the bottom edge of the body. The composite blade system additionally includes a hub connectable to each of the plurality of blade segments via the void and a locking plate connectable to the hub. The locking plate may be for locking a position of the plurality of blade segments about the hub. In some embodiments, a first blade segment is connectable to a second blade segment such that the projection of the first blade segment is received within the slot of the second blade segment.

In some embodiments, a composite blade includes a first plurality of bade segments, where each of the first plurality of blade segments have a cutting edge of a first sharpness. The composite blade also includes a second plurality of bade segments, where each of the second plurality of blade segments have a cutting edge of a second sharpness with the first sharpness being sharper than the second sharpness. The composite blade may also include a hub for receiving the first and second plurality of blade segments. In some embodiments, the first and second plurality of blade segments are alternatingly received by the hub. The composite blade may further include a locking plate connectable to the hub and for locking a position of the first and second plurality of blade segments within the hub.

In some embodiments, a cutting method may include selecting a composite blade having a first outer diameter for a first machine, where the composite blade comprises a plurality of blade segments, a first hub, and a locking plate. The method may also include equipping the first machine with the composite blade through the first hub and performing a cutting process with the first machine using the composite blade. The method may further include selecting a second hub for the composite blade and equipping a second machine with the composite blade through the second hub, where the second hub provides the composite blade with a second diameter for the second machine. The method may include performing a cutting process with the second machine using the composite blade.

FIG. 1 illustrates a plan view of a composite blade 100, in a disassembled configuration, and FIG. 2 illustrates an exploded view of the composite blade 100. As illustrated, the composite blade or blade system 100 includes a plurality of blade segments 10 joined together to form a blade 10A. The composite blade or blade system 100 also includes a hub or receiver 20 for removeably receiving and engaging with the blade segments 10 and/or the blade 10A, a locking plate 30 for locking or maintaining a position of the blade segments 10 within or on the hub 20, and a plurality of pins 50 for attaching the locking plate 30 and the hub 20 together. The pins 50 may also serve to lock the blade segments 10 between and/or within the locking plate 30 and the hub 20.

The hub 20 and the locking plate 30 may accommodate a wide range of blade segment 10 sizes. Specifically, as discussed more fully below, bottom voids of the blade segments 10 engage, mate, fit over, or interact with projections or ridges of the hub 20. Voids or holes of the locking plate 30 also engage, mate, or interact with the ridges of the hub 20 and the bottom voids of the blade segments 10. In this way, the blade segments 10 may be positioned between the hub 20 and the locking plate 30. A length, width, and/or thickness of the blade segments 10 may be varied and the blade segments 10 will still engage the hub 20 and the locking plate 30 through the bottom voids (see, for example, FIGS. 4A-4E).

FIGS. 3A-3B illustrate top and bottom plan views, respectively, and FIG. 3C illustrates a top perspective view of the composite blade 100 of FIGS. 1-2 in an assembled configuration. In FIGS. 3A and 3C, the hub or receiver 20 is clearly illustrated having received the plurality of blade segments 10. FIGS. 3A and 3C also illustrate the pins 50 securing the hub 20, the blade segments 10, and the locking plate 30 together. In FIG. 3B, the locking plate 30 is clearly illustrated having received the plurality of blade segments 10 and a portion of the hub 20.

As discussed more fully below, both the hub 20 and the locking plate 30 define a central cavity 23, 33. The central cavities 23, 33 facilitate attachment of the blade system 100 to a machine to carry out a cutting process. Specifically, a diameter of the central cavities 23, 33 may correlate to a size of blade 100 a particular machine requires. In some embodiments, the diameter of the central cavities 23, 33 is correlated to an outer diameter for the blade 100. For example, the central cavity 23 of the hub 20 may have a diameter ranging from about 20 to 30 mm (such as 22, 25, 25.15, 25.5 mm, etc. or a diameter within a range defined by any two of the foregoing values) corresponding to a blade 100 outer diameter of about 190 to 210 mm (such as 200, 201, 205 mm, etc.). Thus, a machine that requires a blade 100 with an outer diameter of 200 mm may be outfitted with a hub or receiver 20 having a central cavity 23 with a diameter of 25 mm.

The central cavity 33 of the locking plate 30 may have a diameter ranging from about 30 to 50 mm (such as 32, 35, 38.15, 40, 45, 47 mm, etc. or a diameter within a range defined by any two of the foregoing values) corresponding to a blade 100 outer diameter of about 190 to 210 mm (such as 200, 201, 205 mm, etc.). Thus, a machine that requires a blade 100 with an outer diameter of 200 mm may be outfitted with a hub or receiver 20 having a central cavity 23 with a diameter of 25 mm.

Additionally, both central cavities 23, 33 may be sized to support larger blade 100 diameters, such as 300, 350, 400, 500, 550 mm, or a blade diameter within a range defined by any two of the foregoing values.

The composite blades or blade system 100 of the present disclosure can be used in a variety of cutting processes. For example, the blades 100 can be used in a meat cutting process, such as for cutting poultry (e.g., broiler chickens, roaster chickens, ducks, turkeys, etc.) or other types of meat (pigs, cows, sheep, etc.). In particular, the blades 100 may be used to cut through joints, such as in whole wing, wing tip, mid joint, and/or drum and thigh cutting operations. The blades 100 can also be used in textile cutting processes, such as for cutting rugs or large swaths of fabric.

In some embodiments, the blade segments 10 can be used with a variety of differently sized hubs 20 and/or locking plates 30. For example, as mentioned, the hubs 20 and/or locking plates 30 may be sized and shaped for specific machines, and the blade segments 10 are assembled with the hubs 20 and/or locking plates 30 when a particular machine needs to be used in a cutting process. This greatly simplifies the types of inventory a cutting facility needs to keep on hand. Specifically, a cutting facility may keep on hand a variety of hubs 20 and/or locking plates 30, corresponding to the parameters of each machine within the facility. Additionally, the cutting facility may keep on hand the individual blade segments 10 to then be assembled into composite blades 100 as needed. The individual blade segments 10 are smaller than conventional circular blades and can be stacked together to minimize necessary storage space to keep the blade segments 10 in inventory.

FIG. 4A illustrates a close-up view of an individual blade segment 10 and FIGS. 4B-4E illustrate view of blade segments to be used with the composite blade of FIGS. 1-2. As illustrated in FIG. 4A, each blade segment 10 includes a body 11 with a top edge 12, a bottom edge 13, and opposing side edges 14 extending therebetween. The top edge 12 of each blade segment 10 may be the cutting or operational edge for the blade segment 10. For example, the top edge 12 may be a “double beveled” edge to facilitate cutting (see FIG. 4E). In some embodiments, the top edge 12 is not beveled or only includes one bevel to facilitate guiding of a cutting edge. For example, when cutting through a joint, a dull top edge 12 may allow a blade 100 to first break the joint and then a subsequent sharp, cutting edge 12 may cut through the joint. As the blades 100 are typically rotating during a cutting process, a dull top edge 12 can be quickly followed by a sharp top edge 12 to achieve the desired result. In some embodiments, a rotation speed of the blade 100 can be adjusted to achieve a desired cutting result.

The blade segment 10 also includes a projection 15 extending from one side edge 14 and a slot 16 defined within the opposing side edge 14. Each blade segment 10 may be shaped as a sort of puzzle piece to facilitate linking and attachment of one blade segment 10 to the next, adjacent blade segment 10. Specifically, the slot 16 may be for receiving the projection 15 of an adjacent blade segment 10. The mechanical linking of the blade segments 10 may at least partially maintain the segments 10 within a circular, assembled configuration.

The linking of individual blade segments 10 also means that a resulting blade 10A can be mixed and matched with blade segments 10 of a desired characteristic. For example, blade segments 10 with sharp cutting edges 12 may be alternated with blade segments 10 having dull edges 12. As another example, blade segments 10 with a left oriented serration may be alternated with blade segments 10 having a right oriented serration. This may allow for a simple assembly of a serrated blade which, conventionally, is complicated to machine and manufacture.

Each blade segment 10 also includes a bottom void 17 disposed near the bottom edge 13. The bottom voids 17 may be for engaging or mating with projections or ridges of the hub 20 to thereby attach the blade segments 10 to the hub 20 (see FIGS. 5A-5C). Additionally, the bottom voids 17 may interface or engage with the locking plate 30 and/or pins 50 to secure the blade segments 10 within the hub 20 and the locking plate 30. Both the top edge 12 and the bottom edge 13 may have a curvature such that, when the segments 10 are connected together, the blade 100 has an overall circular shape. For example, FIGS. 4C-4E illustrate 8 individual blade segments 10 joined together (via the projections 15 and slots 16) to form a circular blade 10A. However, in some embodiments, any number of segments 10 may be joined together, such as 2-10 blade segments 10. The circular blade 10A has a central cavity 18 that is formed by each bottom edge 13 of the individual blade segments 10. The central cavity 18 may receive portions of the hub 20 and/or the locking plate 30 when the segments 10 are joined together in the blade system 100.

As seen in FIGS. 4D-4E, the blade 10A or blade segments 10 may include one or more bevels 19. In some embodiments, the bevels 19 are located between individual blade segments 10, such as when the blade segments 10 are dull. In some embodiments, individual blade segments 10 include bevels 19 between segments 10 as well as a bevel 19 within a substantial middle of the top edge 12 of the segment 10. This may be referred to as a “double bevel” and may be included in segments 10 that have cutting edges.

FIG. 5A illustrates a bottom view, FIG. 5B illustrates a top view and FIG. 5C illustrates a side view of the hub or receiver 20 from the composite blade or system 100 of FIGS. 1-2. The hub 20 may include a body 21 having a circumferential edge 22 and a central cavity 23 defined by the body 21. Extending from the bottom of the central cavity 23 may be a flange or extension 26. When blade segments 10 are disposed on the hub 20 (e.g., when the bottom voids 17 are disposed over the ridges 24), the bottom edge 13 of each blade segment 10 may abut or interface with the extension 26. This may aid in accurate placement of the blade segments 10 on the hub 20. As seen in FIGS. 5B-5C, the hub 20 may include a beveled or chamfered edge 27. The chamfered edge 27 may allow for a close and tight fit of the hub 20 against the blade segments 10, as well as a close fit of the blade 100 within a machine.

Disposed about the body 21 are a plurality of ridges 24. In some embodiments, the ridges 24 are disposed near the circumferential edge 22; in other embodiments, the ridges 24 are disposed about a center or middle of the body 21. The ridges 24 may be sized and shaped such that they receive (or are received by) the bottom voids 17 of each blade segment 10. Each ridge 24 may define or include a void 25 that extends from a top of each ridge 24 through to a bottom of each ridge 24. The voids 25 may be for receiving fasteners, such as pins 50 or other screws, clips, snaps, nails, etc. Some of the voids 25 may be elongated voids 25a, that allow for rotation of the hub 20 and/or blade segments 10 around a pin 50. This rotation may provide a locking function to the hub 20 before the locking plate 30 is attached to the blade system 100.

FIG. 6A illustrates a perspective bottom view, FIG. 6B illustrates a top view and FIG. 6C illustrates another bottom perspective view of the locking plate 30 (and pins 50) from the composite blade 100 of FIGS. 1-2. As illustrated, the locking plate 30 includes a body 31 having a circumferential edge 32 and a central cavity 33 defined by the body 31. Disposed about and defined by the body 31 are a plurality of holes 35 which may be for receiving fasteners, such as pins 50 or other screws, clips, snaps, nails, etc. At least one of the voids is a square or cuboid void 36 which may be for receiving a locking pin (see FIGS. 7A-7C). The voids 35 may be sized and shaped according to the fastener they are receiving. Additionally, voids 35 may be sized and shaped to correspond to the voids 25 within the ridge 24 of the hub 20. Specifically, the voids 35 may align with the voids 25 such that a fastener (e.g., a pin 50) may be received by and pass through both voids 25, 35 to thereby attach the hub 20 and the locking plate 30 together (with the blade segments 10 sandwiched therebetween).

The central cavity 33 may be aligned with the central cavity 23 of the hub 20. Additionally, the central cavity 33 may receive the flange or extension 26 of the hub 20. Reception of the flange 26 within the central cavity 33 and alignment of the voids 25, 35 may lock or maintain a position of the blade segments 10 within both the hub 20 and the locking plate 30. Such maintenance may allow the assembled blade 100 to be positioned within a machine for a cutting process.

As seen in FIG. 6C, the locking plate 30 and the voids 35, 36 receive and interface with a plurality of pins 50. The square void 36 is for receiving a locking pin 40 that may facilitate a locked position between the hub 20, the blade segments 10, and the locking plate 30. Though illustrated next to the locking plate 30, the pins 50, 40 may pass (i) first through voids 25 within the ridge 24 of the hub, (ii) through the bottom voids 17 of each blade segment 10, and (iii) then through the voids 35, 36 of the locking plate 30. The pins 50 may screw into each void (25, 13, 35, 36) or may pass through the voids and be secured with a nut.

FIG. 7A illustrates a perspective view, FIG. 7B illustrates a top view, and FIG. 7C illustrates a bottom view of a locking pin 40. The locking pin 40 may have a body 41 with a top platform 42 and a bottom platform 43. In some embodiments, the top platform 42 has one or more chamfered edges 44 that may allow for a tight fit of the locking pin 40 with the void 36 of the locking plate 30. Additionally, the chamfered edges 44 may facilitate a grip on the locking pin 40 by a user during installation or assembly of the blade 100. Both the top and bottom platforms 42, 43 may have a rounded cuboid configuration. In some embodiments, the top rounded cuboid 42 is offset from the bottom rounded cuboid 43 by about 90-degrees. The rounded cuboid configuration of the locking pin 40 may facilitate placement of the bottom platform 43 through hub 20 and the locking plate 30. The offset nature of the top platform 42 may facilitate locking of the locking pin 40 within the void 36, as only one platform may be positioned through the void 36 at a time (see void 36 and locking pin 40 in FIG. 6C).

This arrangement may be particularly advantageous for maintaining a secured and assembled configuration of the blade 100 while the blade 100 is used during a cutting operation. For example, during a cutting operation, the blade 100 will be spinning or rotating at a particular speed or rotations-per-minute (rpms). Such rotation may exert separating forces between the blade segments 10, the hub 20, and the locking plate 30. The locking pin 40 may assist in keeping the blade 100 together during the cutting operation as the locking pin 40 must be turned 90-degrees in order to remove the locking pin 40 from the void 36.

FIGS. 8A-8C illustrate views of a pin 50 for attaching and securing the blade segments 10, the hub 20, and the locking plate 30 together. The pin 50 may include a body 51 having a top platform 52 and a bottom end 53. The pin 50 may be a “flat” pin 50, where the top platform 52 rests against the hub 20. The body 51 may extend through the hub 20, the blade segments 10, and the locking plate 30. In some embodiments, the top platform 52 includes one or more chamfered edges 54 that may allow for a tight fit of the pin 50 with the hub 20. Additionally, the chamfered edges 54 may facilitate a grip on the pin 50 by a user during installation or assembly of the blade 100.

FIGS. 9A-9C illustrate additional views of the composite blade 100 of FIGS. 1-2 in various disassembled configurations. The bottom voids 17 of the individual blade segments 10 are clearly illustrated as engaging with ridges 24 (only one is labelled) of the hub 20. As shown in FIG. 9A, different sized blade segments 10 can be attached to the hub 20 to accommodate various cutting operations. The blade segments 10 can be altered in both length (measured from the bottom edge 13 to the top edge 12) or width (measured between opposing side edges 14). In this way, a blade 100 can be assembled according to the parameters for a given machine in a cutting operation. In some embodiments, only the hub 20 and locking plate 30 are changed when assembly a new blade 100 for a new machine.

As mentioned before, the blade segments 10 can be mixed and matched for a desired cutting process and/or a particular cutting machine. Specifically, different blade segments 10 having different cutting edges 12 or characteristics (e.g., serrations) may be assembled together to create a blade 10A (see FIGS. 4D-4E). This imparts an additional level of customization for cutting facilities and cutting machines. This also means cutting facilities need to keep fewer individual blades on hand as blades 10A can be assembled on-demand for a particular cutting operation, leading to decreased costs in time, money, and space for users.

Additionally, this means that individual blade segments 10 can be replaced as they wear out or break. Accordingly, rather than throw out entire blades 10A, individual segments 10 can be replaced as needed leading to overall reductions in waste. Further, individual segments 10 can be removed, sharpened, and replaced, also leading to overall reductions in waste. Still further, as individual segments 10 are sharpened rather than entire blades 10A, the sharpening process can be both faster and more precise for each segment 10, leading to better sharpness and cutting characteristics for both each segment 10 and the blades 10A they are incorporated into.

FIGS. 10A-10B illustrate another embodiment of a composite blade 101 according to the present disclosure. As with composite blade 100, the composite blade 101 of FIGS. 10A-10B includes the plurality of blade segments 10, the hub 20, and the locking plate 30. In this embodiments, the hub 20 and the locking plate 30 may snap or clip together where pins of the locking plate 30 (not illustrated) may snap into voids of the hub 20 (not illustrated). The blade segments 10 may still be sandwiched between the hub 20 and locking plate 30, and secured to each of the hub 20 and locking plate 30 through bottom voids 17 (not illustrated).

FIGS. 11A-11B illustrate a comparison of the blade segments 10 from FIGS. 4A-4E to a conventional circular blade 90. As described, the blade segments 10 can be designed and manufactured to have any cutting edge 12 or characteristic, such as serrations, breaking or dulled edges, cutting edges, etc. The individual nature of the blade segments 10 allows for more precise machining and formation of the cutting edges 12. Additionally, as indicated by the lines in FIG. 11B, the individual nature of the blade segments 10 allows for alignment of the blade characteristics along a grain of the metal used to manufacture the blade segments 10. Better alignment of the grain during manufacture of the blade segments 10 means each individual blade segment 10 maintains the strength of the metal it is manufactured from.

In contrast, conventional circular blades 90 are not aligned, or are poorly aligned, with the grain of the metal across an entirety of the blade 90. Thus, portions of the blade 90 may be weaker than other portions of the blade 90, which may lead to premature failure (e.g., breakage) of the blade 90.

The disclosed composite blades (and/or blade segments) provide a stronger, longer lasting product that uses far less material to manufacture, less time to maintain its proper bevel and serration, and produces a cleaner cut with up to a 15-25% better anatomical cut (e.g., in a poultry cutting process), resulting in more final (food) product with each pass. This new blade system 100 can be easily adapted to any processor's current equipment and cutting process, even if they use more than one manufacturer's machine or process different products (e.g., poultry versus red meats versus textiles). This new system's use of interchangeable, interlocking blade segments 10 allows the processor to introduce the assembled blade to any processing machinery simply by replacing the manufacturer-specific hub with the hub 20 and locking plate 30 of the present system 100.

In addition to the system 100 not being manufacturer-specific, its uniqueness also comes from the blade design within the new system 100. Rather than a single blade machined to make the processor's desired cut, the disclosed blade system 100 use a segmented interlocking set of “partial” blades 10 that can be manufactured to any precise cutting bevel or serration. These “partial” blades 10 are then assembled into a single blade with a cutting pattern that creates (or recreates) exactly what each processor needs to complete their cut in the most efficient way. These complete cutting blade systems can be made in all diameters for any food industry requiring this anatomical cut.

Additionally, the blade segments or partial blades 10 allow for more efficient manufacturing, such as when creating a layout of blade segments 10 on stainless steel sheets for manufacturing these smaller blade segments 10 rather than the layout needed for whole circular units, generating less waste. By manufacturing smaller blade segments 10 rather than one circular blade 90, the blade manufacturer is able to align each blade segment 10 in parallel with more of the steel's natural grain (see the lines in FIG. 10B), which gives each blade segment 10 a consistent strength increase, leading to less potential breakage or failure of each segment 10. Instead of trying to machine a complex edge pattern while working on a large single blade, each smaller blade segment 10 can be machined precisely, and then assembled into the desired pattern in the new design blade.

Blade segments 10 can be machined with any necessary bevel or serration and arranged in any order to get the desired cut result or for unique cutting requirements. If necessary, a single blade segment 10 can be removed for reworking, or a new blade segment 10 can be substituted quickly in a food processing setting, instead of a whole blade, saving costs, material, and time. The disclosed cutting blade systems 100 allow for easy changes of blade segments 10 on demand and in a developmental setting, where a new use or new machine is being developed, instead of a whole blade replacement as development is occurring.

Since the cutting blade systems are made of smaller, interchangeable parts, rather than the typical single use/single manufacturer blade for each processing machine, it would not be necessary to store multiple versions of circular blades in inventory. It would be much easier and less expensive to order, ship, store and maintain an inventory of the interchangeable parts. The system's blade parts can be single sourced.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a cutting process (e.g., poultry or meat cutting); however, other process (e.g., textiles, plastics, etc.) are also contemplated. Structures or surfaces that abut the blade segments are referred to as “bottom” while structures or surfaces that are opposite the surfaces abutting the blade segments are referred to as “top.” A top side of a hub faces a user while the user equips a machine with the blade.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A composite blade system comprising:
a plurality of blade segments, each segment comprising:
a body having a top edge, a bottom edge, and opposing side edges extending therebetween,
a projection on a first side edge of the body,
a slot on a second side edge of the body opposite the first side edge, and
a void disposed near the bottom edge of the body;
a hub connectable to each of the plurality of blade segments via the void; and
a locking plate connectable to the hub, the locking plate for locking a position of the plurality of blade segments about the hub,
wherein a first blade segment is connectable to a second blade segment such that the projection of the first blade segment is received within the slot of the second blade segment.

2. The composite blade system of claim 1, wherein the top edge of the blade segments comprises a cutting edge.

3. The composite blade system of claim 1, wherein the top edge of the blade segments comprises a serrated edge.

4. The composite blade system of claim 1, wherein the plurality of blade segments comprises 8 identical blade segments.

5. The composite blade system of claim 1, wherein the plurality of blade segments comprises 4 blade segments of a first sharpness and 4 blade segments of a second sharpness.

6. The composite blade system of claim 1, wherein the plurality of blade segments comprises 4 left-serrated blade segments and 4 right-serrated blade segments.

7. The composite blade system of claim 6, wherein the 4 left-serrated blade segments are alternated with the 4 right-serrated blade segments.

8. The composite blade system of claim 1, wherein the hub and the locking plate connect with a snap fit.

9. The composite blade system of claim 1, wherein the plurality of blade segments comprises 2 non-identical blade segments.

10. A composite blade comprising:
a first plurality of blade segments, each of the first plurality of blade segments having a cutting edge of a first sharpness;
a second plurality of blade segments, each of the second plurality of blade segments having a cutting edge of a second sharpness, the first sharpness being sharper than the second sharpness;
a hub for receiving the first and second plurality of blade segments,
wherein the first and second plurality of blade segments are alternatingly received by the hub; and
a locking plate connectable to the hub and for locking a position of the first and second plurality of blade segments within the hub.

11. The composite blade of claim 10, wherein each of the first and second plurality of blade segments are replaceable.

12. The composite blade of claim 10, wherein the hub comprises a substantially circular body defining a central hole and a plurality of extensions, the plurality of extensions for engaging with a distal void of each of the first and second plurality of blade segments.

13. The composite blade of claim 12, wherein the central hole of the hub is for engaging/interfacing with a machine using or equipped with the composite blade.

14. A cutting method comprising:
selecting a composite blade having a first outer diameter for a first machine, the composite blade comprising a plurality of blade segments, a first hub, and a locking plate;
equipping the first machine with the composite blade through the first hub;
performing a cutting process with the first machine using the composite blade;
selecting a second hub for the composite blade;
equipping a second machine with the composite blade through the second hub, the second hub providing the composite blade with a second diameter for the second machine; and
performing a cutting process with the second machine using the composite blade.

15. The cutting method of claim 14, wherein the plurality of blade segments and the locking plate are the same for the first hub and the second hub of the composite blade.

16. The cutting method of claim 14, wherein the cutting process comprises cutting poultry or meat products.

17. The cutting method of claim 14, wherein the plurality of blade segments comprise a first plurality of blade segments having a single bevel/dull edge and a second plurality of blade segments having a double bevel/sharp cutting edge.

18. The cutting method of claim 14, further comprising:
selecting a third hub for the composite blade, the third hub having a third outer diameter for a third machine; and
performing a cutting process with the third machine.

19. The cutting method of claim 18, wherein the plurality of blade segments and the locking plate are the same for the first hub, the second hub, and the third hub of the composite blade.

20. The cutting method of claim 14, wherein the composite blade is selected based on a type of product being cut and a desired outcome for the type of product being cut.
